(19) United States
(12) Patent Application Publication
(10) Pub. No.: US 2014/0299420 A1
(43) Pub. Date: Oct. 9, 2014

(54) ELEVATOR

(71) Applicant: KONE CORPORATION, Helsinki (FI)

(72) Inventor: Tuomo HAKALA, Toyama (JP)

(21) Appl. No.: 14/310,687

(22) Filed: Jun. 20, 2014

Related U.S. Application Data
(63) Continuation of application No. PCT/FI2013/050036, filed on Jan. 15, 2013.

(30) Foreign Application Priority Data
Jan. 16, 2012 (FI) 20125046

(51) Int. Cl. B66B 5/18

(52) U.S. Cl. CPC B66B 5/18
USPC 187/361

(57) ABSTRACT

Elevator, which includes an elevator hoistway, an elevator car configured to move with a certain range of movement in the elevator hoistway, a brake on the elevator car, which brake can be displaced between a braking state and a non-braking state, in which braking state the brake is configured to grip a structure in the elevator hoistway for braking the elevator car, and a rope loop, which rope loop hangs in its position supported by the diverting pulley of the top end, said diverting pulley being supported in a manner allowing rotation in the proximity of the top end of the range of movement of the elevator car, and the rope loop is connected to the aforementioned brake, which brake is configured to be such that it can displace into a braking state as a consequence of a pull exerted on the brake by the rope loop. The rope loop comprises consecutive to each other a first section and second section, which have average masses per meter of different magnitudes.

### FIELD OF THE INVENTION

The object of the invention is an elevator, which elevator is preferably an elevator applicable to the transporting of a person and/or of freight.

### BACKGROUND OF THE INVENTION

The invention relates to a brake, more particularly an emergency brake, in connection with an elevator car of an elevator. In elevators according to prior art a brake is in connection with the elevator car, the braking of which brake can be started in an overspeed situation e.g. if the elevator car goes into free-fall. This type of safety arrangement is necessary e.g. for situations in which the roping suspending the elevator car breaks. The brake must be sufficiently effective for the deceleration of the elevator car to be sufficient. On the other hand, the brake may not be too effective, so that the passengers in the interior of the elevator car will not be injured. What is advantageous, and in many countries even essential, is that the deceleration is between 0.2-1.0 G. A problem in elevators according to prior art has been to achieve a suitable deceleration that is independent of the location of the elevator car at the time of braking. It has been necessary for the brake arrangement, whether it comprised one brake or more than one, to be able to stop a moving mass that comprises, in addition to the mass of the elevator car, the masses of the ropes hanging from it. Numerous ropes or ropings hanging supported by the elevator car are generally connected to the elevator car. These types of ropes can be a rope/roping (e.g. compensating roping) passing around a diverting pulley supported on the bottom end of the elevator hoistway or the trailing cable of the elevator, with which cable electricity and/or data is transferred to the elevator car/from the elevator car. The roping hanging supported by the elevator car moves when moved by the elevator car and exerts a downward-pulling force on the elevator car, the magnitude of which force varies according to the location of the elevator car, being at its greatest when the elevator car is at the top end of its range of movement and at its smallest when the elevator car is at the bottom end of its range of movement. The magnitude of the mass to be braked varying as a function of car position has also caused the situation that the power of the necessary braking should be varied correspondingly, i.e. to be of a different magnitude at different points of the hoistway. Owing to this phenomenon it has been awkward to dimension a brake to be such that it stays within the target deceleration range even if braking were started close to the end of the hoistway. More particularly when the elevator is an elevator with a very high travel height, and the masses of the roping clearly form most of the moving masses of the elevator, a brake has had to be dimensioned to be very effective for situations in which the elevator car goes into free-fall when it is in the top parts of the elevator hoistway.

Taking the preceding into account, a need has arisen to achieve a solution wherein the effect of the ropes hanging from the elevator car on the deceleration brought about with braking is less than before.

### BRIEF DESCRIPTION OF THE INVENTION

The aim of the invention is to produce an elevator that is improved with respect to the brake arrangement. The aim of the invention is further to solve the aforementioned problems of prior-art solutions as well as the problems disclosed in the description of the invention below. Some embodiments, inter alia, are disclosed with which it is possible to, inter alia, affect power of the braking of the elevator car based on the location of the elevator car in the elevator hoistway.

According to the invention the elevator comprises an elevator hoistway, an elevator car configured to move with a certain range of movement in the elevator hoistway, and a brake on the elevator car, which brake can be displaced between a braking state and a non-braking state, in which braking state the brake is configured to grip a structure in the elevator hoistway for braking the elevator car. The elevator further comprises a rope loop, which rope loop hangs in its position supported by the diverting pulley of the top end, said diverting pulley being supported in a manner allowing rotation in the proximity of the top end of the range of movement of the elevator car, and the rope loop is connected to the aforementioned brake, which brake is configured to be such that it can displace into a braking state as a consequence of a pull exerted on the brake by the rope loop. The brake is in this case preferably configured to displace into a braking state when the forces exerted on the brake fulfill certain criteria. The rope loop comprises a first section and a second section that are consecutive to each other and have average masses per meter of different magnitudes. When the elevator car moves between the extreme ends of its range of movement, the sections of different weights displace over the highest point or under the lowest point of the rope loop, in which case their direction of travel changes, which changes the balance of the rope loop. The pull on the brake caused by the inertia of the rope loop in an acceleration situation of the car is thus dependent on the car position. Thus the magnitude of the pull can be made to change on the basis of car position and acceleration. By selecting the location of the sections suitably the conditions, more particularly the location and acceleration of the elevator car, in which the rope loop exerts the maximum pull on the brake can be defined. The brake can be configured to trigger when the forces exerted on it fulfill certain criteria.

Preferably the heavier section of the aforementioned sections is arranged to run over the diverting pulley of the top end from the second side of the diverting pulley to the first side when the elevator car descends. In this way the heavier section displaces away from hanging supported by the brake. The balance of the rope loop changes, the portion of the heavier section moving upwards decreases and the inertia decreases. Thus when the elevator car descends, the maximum forces exerted on the brake by the action of the rope loop decrease. In this way a reduction in the pull can be simply brought about when the elevator car descends.

Preferably the elevator comprises a diverting pulley of the bottom end supported in a manner allowing rotation in the proximity of the bottom end of the range of movement of the elevator car, under which diverting pulley the rope loop travels and from which diverting pulley the rope loop continues upwards to the aforementioned diverting pulley of the top end, and the light section is arranged when the elevator car descends to run below the diverting pulley of the bottom end and to rise towards the diverting pulley of the top end. In this way the light section displaces to hang supported by the brake instead of the heavier section. The balance of the rope loop changes, the portion of the heavier section moving upwards decreases and the inertia decreases. Thus when the elevator car descends, the maximum forces exerted on the brake by the action of the rope loop decrease. In this way a reduction in the pull can be simply obtained when the elevator car descends.

Preferably the part of the rope loop that is on the first side of the diverting pulley of the top end and that runs from the diverting pulley of the top end down to the car is connected to the brake such that it can transmit a pull of the rope loop to the brake. The rope loop on the second side of the diverting pulley can thus hang supported by the brake, in which case when the elevator car moves downwards from its upper position the brake pulls the part of the rope loop in question upwards.

Preferably the part of the rope loop on the first side of the diverting pulley of the top end is connected to a means for starting braking of the brake in such a way that pull of the rope is transmitted to the starting means, and that the brake is configured to displace into a braking state when the forces exerted on the starting means fulfill certain criteria, e.g. when the resultant of the forces is of a certain magnitude and direction. In this way the braking can be simply formed to be stepped and the brake does not “drag” in situations in which braking is not required.

Preferably the starting means is mechanically connected to a brake pad, which is arranged to be compressed against a guide rail of the elevator for braking the elevator car. Preferably the brake is a brake that grips a guide rail of the elevator car (operating on the wedging principle), in which the brake pad wedges between a wedge housing and a guide rail of the elevator car. In this way safe braking can be achieved. This type of brake has proven to be reliable.

Preferably the elevator comprises a hoisting machine, which is connected to the elevator car via the hoisting roping, and the aforementioned rope loop is separate from the hoisting roping.

Preferably the elevator comprises ropes hanging from the elevator car, such as ropes belonging to the hoisting roping of the elevator or a trailing cable. In this type of elevator there is a special advantage from triggering of the brake based at least on car position. Of course, there can be other reasons for desiring to achieve this type of triggering of the brake.

Preferably braking of the brake is adjusted to start as a consequence of the aforementioned pull in only a part of its range of movement (preferably in the top part of the elevator hoistway) and if the elevator car is accelerating downwards at a certain acceleration.

Preferably the brake comprises a spring, which resists the aforementioned pull and when the pull overcomes the spring force, braking starts. In this way the triggering of the brake can be simply adjusted to occur only in certain conditions.

Preferably the loop comprises a loop half that is heavier in its average mass per meter and a loop half that is lighter in its average mass per meter, which heavier half rises up from the elevator car and the lighter half descends downwards from the elevator car.

Preferably the rope loop comprises a first section, which descends downwards from the car, and following it the aforementioned second section, which continues back to the car traveling over the aforementioned diverting pulley of the top end, which second section is heavier in its average mass per meter than the first section.

Preferably the light section and heavy section have an essentially constant mass per meter over their whole length, or at least over most of their length.

Preferably the border point of the light section and the heavy section rises in the elevator hoistway when the elevator car descends.

Preferably the elevator also comprises a second brake (5′) on the elevator car, which brake can be displaced between a braking state and a non-braking state, in which braking state the brake is configured to grip a structure in the elevator hoistway for braking the elevator car, and also means for displacing the second brake (5′) between a braking state and a non-braking state. Preferably these means form an overspeed governor and displace the second brake (5′) into a braking state when the speed of the elevator car exceeds a predefined speed. Preferably these means comprise a rope loop connected to the second brake, which rope loop rotates when rotated by the movement of the elevator car, and means which brake the movement of the rope loop after the speed exceeds a predefined speed. Preferably the rope loop is connected to the second brake such that the brake can be displaced into a braking state by the aid of a pull exerted on the brake by the rope loop in question. The operating principle of the second brake can be similar to the brake mentioned earlier. In this case the brakes can be arranged to trigger with different criteria and e.g. the brake mentioned earlier can supplement the braking of the second brake according to need, or vice versa.

Preferably the brake mentioned earlier and the second brake are connected to each other in such a way that triggering of the brake mentioned earlier causes triggering of the second brake but triggering of the second brake does not cause triggering of the brake mentioned earlier. An advantage of this is that the brake mentioned earlier can be arranged to trigger only in the top parts of the elevator hoistway, in which the need for braking is greatest. This can be achieved e.g. by the aid of force transmission transmitting force in only one direction between the brakes.

The elevator is most preferably an elevator applicable to the transporting of people and/or of freight, which elevator is installed in a building, to travel in a vertical direction, or at least in an essentially vertical direction, preferably on the basis of landing calls and/or car calls. The elevator car preferably has an interior space, which is most preferably suited to receive a passenger or a number of passengers. The elevator preferably comprises at least two, preferably more, floor landings to be served. Some inventive embodiments are also presented in the descriptive section and in the drawings of the present application. The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. The features of the various embodiments of the invention can be applied within the framework of the basic inventive concept in conjunction with other embodiments.

### BRIEF DESCRIPTION OF THE FIGURES

The invention will now be described mainly in connection with its preferred embodiments, with reference to the attached drawings, wherein

FIG. 1 presents one embodiment of an elevator according to the invention.

FIG. 2 presents the elevator of FIG. 1 in free-fall.

FIG. 3 presents a second embodiment of an elevator according to the invention.

FIG. 4 presents the elevator of FIG. 3 in free-fall.

FIG. 5 presents a structure for a brake according to one embodiment.

FIG. 6 presents a structure for a brake and for a second brake according to one embodiment.

### DETAILED DESCRIPTION OF THE INVENTION

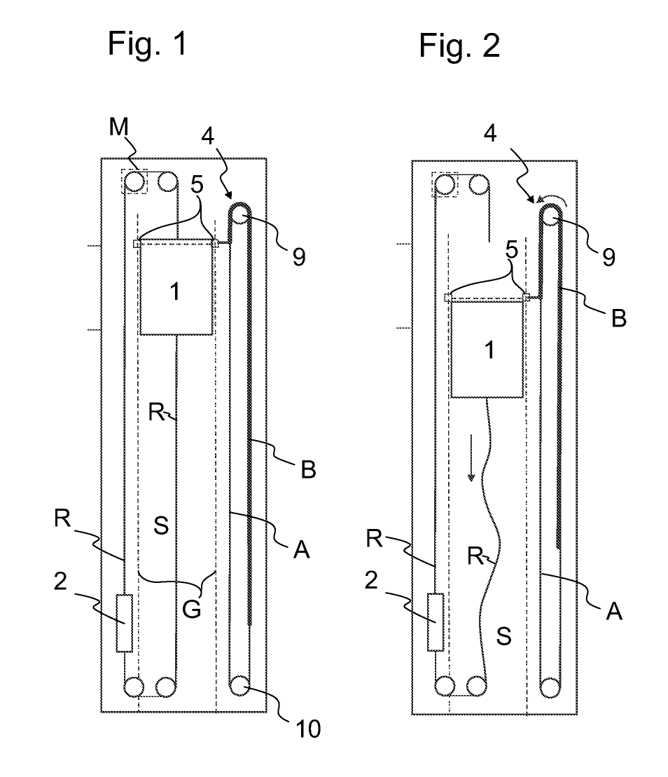

FIG. 1 presents an elevator according to one embodiment, which comprises an elevator hoistway S, an elevator car 1 configured to move with a certain range of movement in the elevator hoistway S, a brake 5 on the elevator car 1, which brake can be displaced between a braking state and a non-braking state, in which braking state the brake 5 is configured to grip a structure G in the elevator hoistway S for braking the elevator car 1. The structure G is an essentially continuous structure in the direction of the movement of the elevator car 1 in the elevator hoistway, in which case it can be gripped regardless of the location of the elevator car. In the embodiment presented the structure G is a guide rail guiding the movement of the elevator car 1 in the hoistway. The elevator further comprises a rope loop 4, which rope loop 4 rotates when rotated by the movement of the elevator car, and hangs in its position supported by the diverting pulley 9 of the top end, said diverting pulley being supported in a manner allowing rotation in the proximity of the top end of the range of movement of the elevator car 1. The rope loop 4 is connected to a brake 5, which is configured to be such that it displaces into a braking state as a consequence of a pull of a certain magnitude and direction exerted on the brake 5 by the rope loop 4. The rope loop 4 comprises a first section A and a second section B consecutive to each other, which have average masses per meter of different magnitudes. The rope loop is arranged to rotate when rotated by the movement of the elevator car, in which case the positions of its consecutive sections A and B change such that the masses of the halves between the highest point and the lowest point of the loop 4 change, in which case the pull being transmitted to the brake changes when the location of the elevator car changes. In this way the pull to be exerted on the brake can be configured to vary according to the location of the elevator car. The elevator can also comprise a counterweight 2, which is not, however, indispensable.

The rope loop 4 comprises a first section A, which descends downwards from the car, and following it a second section B, which continues back to the car traveling over the aforementioned diverting pulley of the top end, which second section B is heavier than the first section in its average mass per meter. The elevator comprises a diverting pulley of the bottom end, said diverting pulley being supported in a manner allowing rotation in the proximity of the bottom end of the range of movement of the elevator car, under which diverting pulley the rope loop travels and from which the rope loop continues upwards to the aforementioned diverting pulley 9 of the top end, and the light section A is arranged when the elevator car 1 descends to run below the diverting pulley 10 of the bottom end and to rise towards the diverting pulley 9 of the top end. The part of the rope loop 4 running from the diverting pulley 9 of the top end to the car, which part is on the first side (on the left-hand side in the figure) of the diverting pulley, is connected to the brake 5, which is configured to be such that it can displace into a braking state as a consequence of a pull exerted on the brake 5 by the rope loop 4 running from the diverting pulley 9 to the car. The heavier section B of the aforementioned sections (A, B) is arranged to run over the diverting pulley 9 of the top end from the second side of the diverting pulley 9 to the first side when the elevator car 1 descends. In this way it is brought about that, alongside gravity, the inertia of the rope loop 4 is a factor increasing the pull exerted on the brake 5 when the downwards movement of the elevator car 1 accelerates. In this case the location of the car 1 does not alone function as the triggering factor of the brake 5, but instead also the acceleration of the elevator car and the direction of the acceleration affect the pull and thereby whether the brake triggers, i.e. whether the brake displaces into a braking state. When the elevator car descends from its topmost position, the heavier section A travels upwards. Thus, if the downward movement of the elevator car accelerates, the portion of the section A travelling towards the diverting pulley 9 must accelerate upwards, which increases the pull being transmitted to the brake 5. The pull exerted on the brake 5 by this phenomenon is smaller the lower in the hoistway the elevator car is, because the lower the elevator car is, the farther the heavier section B has passed around the diverting pulley 9 to the first side, and the farther the light section has passed under the diverting pulley 10 to rise towards the diverting pulley 9. In this way the amount of mass accelerating upwards decreases as the elevator car displaces lower in the hoistway. In this case preferably the border point of the light section and the heavy section rises in the elevator hoistway when the elevator car descends. When the elevator car is in its upper position between the diverting pulley of the top end and the diverting pulley of the bottom end, the half of the loop 4 on the right-hand side in the figure is heavier than the remainder of the loop.

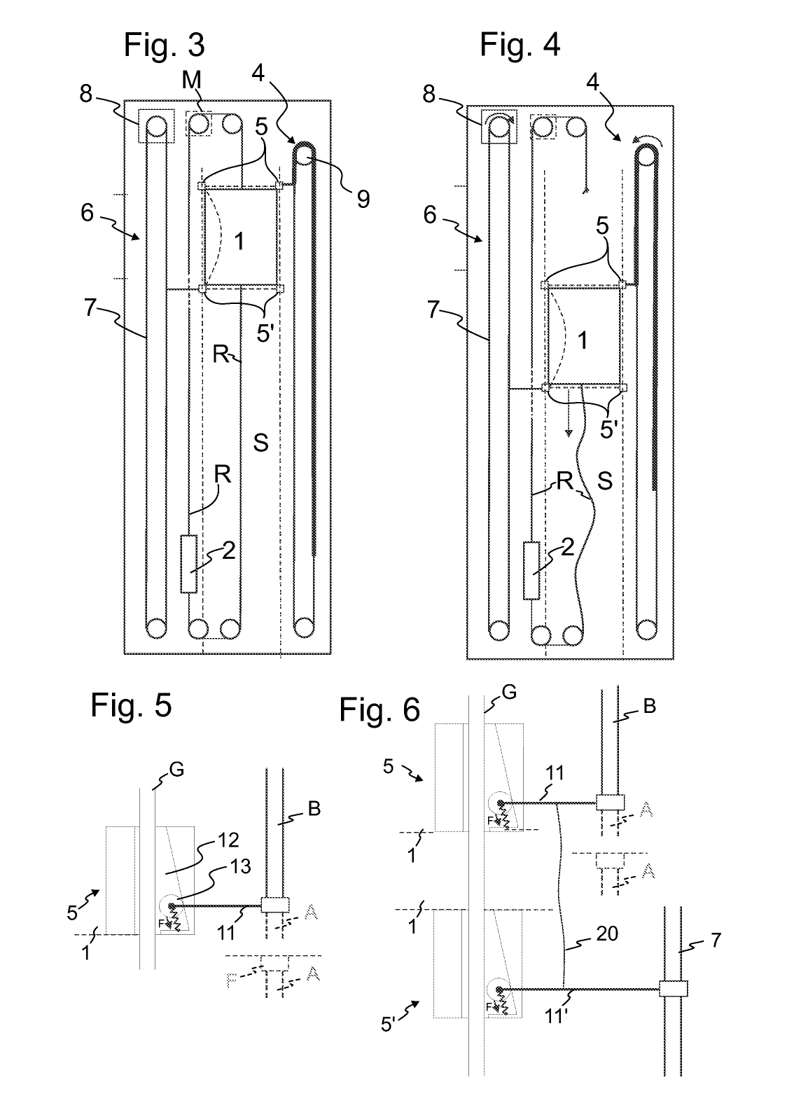

Preferably the elevator is of such a type that it comprises a hoisting machine M, which is connected to the elevator car via hoisting roping R, from which hoisting roping the aforementioned rope loop 4 is separate. The brake solution presented solves particularly the problems in the type of elevator presented, which elevator comprises ropes hanging from the elevator car 1, such as ropes R belonging to the hoisting roping of the elevator or a trailing cable. Structurally the brake 5 can be e.g. any brake according to prior art, for which pulling can be used to trigger the brake. FIG. 5 presents a preferred structure for the brake 5. When the brake 5 is according to FIG. 1 or 3, the rope part on the first side of the diverting pulley (9) of the top end of FIG. 5 is connected to a means 11 for starting braking of the brake of the elevator car in such a way that pull of the rope is transmitted to the starting means 11, and that the brake 5 is configured to displace into a braking state when the forces exerted on the starting means fulfill certain criteria, preferably when the resultant of the forces is of a certain magnitude and direction. In the solution presented the starting means is mechanically connected to a brake pad 13, which is arranged to be compressed against a guide rail G of the elevator for braking the elevator car 1. The brake is a brake that grips a guide rail G of the elevator car (operating on the wedging principle), in which the brake pad wedges between a wedge housing and a guide rail of the elevator car, but the brake could also be of another type. Hitting of the brake pad 13 against the guide rail G causes wedging. The rope loop 4 can be connected to the brake 5 either at both its ends or at one of its ends, which alternatives are presented in the figure with a dashed line. If the loop 4 is connected at only one of its ends, the other end is supported e.g. on some other part F of the elevator car 1. In practice it is advantageous to use a spring that resists the aforementioned pull for determining the suitable pull triggering the brake, in which case braking starts when the pull overcomes the spring force. In this way the braking can be adjusted to start only when the elevator car is in a certain area in the elevator hoistway and accelerating downwards at a certain acceleration. Whether the section of the loop 4 leaving downwards from the elevator car 1 is suspended supported by the frame of the elevator car or whether it is also connected to the starting means 11 is also taken into account in the adjustment. In the figure the starting means 11 is a lever rigidly fixed to the rope loop, which lever transmits the pull of the rope loop to the brake pad 13.

The aforementioned light section A and aforementioned heavy section B preferably have an essentially constant mass per meter. In this case the average mass per meter of the section is the same as its mass per meter. In this case the rope loop can be simply formed to comprise ropes connected to each other consecutively that are of a different mass per meter. As presented in the figure, it is advantageous that when the elevator car is in its upper position, i.e. stopped at the point of the topmost floor landing, the heavier section reaches to travel over the diverting pulley of the top end. In this case the border point between the sections A and B does not necessarily travel over the diverting pulley 9. In the figures the heavier section B is described as thicker than the section A.

FIGS. 3-4 describe a second preferred embodiment, which is similar to the embodiment of FIGS. 1-2 with the difference that it also comprises a second brake 5′ on the elevator car, which brake can be displaced between a braking state and a non-braking state, in which braking state the brake is configured to grip a structure in the elevator hoistway for braking the elevator car, and also means (7,8) for displacing the second brake 5′ between a braking state and a non-braking state. The means 7, 8 form an overspeed governor 6 and displace the second brake 5′ into a braking state when the speed of the elevator car 1 exceeds a predefined speed. The means 7, 8 comprise a rope loop 7 connected to the second brake, which rope loop rotates when rotated by the movement of the elevator car 1, and means 8, which brake the movement of the rope loop after the speed exceeds a predefined speed. The rope loop is connected to the second brake 5′ such that the second brake 5′ can be displaced into a braking state by the aid of a pull exerted on the brake by the rope loop in question. The means 8 can be formed e.g. on some principle according to prior art (e.g. in the manner described by publication WO 2009130366 or WO 2011128492 or EP 0662445). In this case the brakes 5 and 5′ can supplement each other. Triggering of the brake 5′ can e.g. be possible when the car is in any part of the hoistway whatsoever, whereas triggering of the brake 5 is possible only in the top part of the hoistway.

The guide rails G of the elevator are drawn in the figures in such a way that the elevator comprises two guide rail lines and brakes 5 and 5′, two pieces of each of which corresponding to each own guide rail G. The brakes 5 are synchronized with each other in such a way that activation of the one results in activation of the other, so that the rope loop 4 must be connected to only one brake. The synchronization can be implemented e.g. with some synchronization lever system according to prior art. Correspondingly, in the embodiment of FIGS. 3 and 4 the brakes 5′ are synchronized with each other in the same way and correspond to the guide rails G of the elevator. The synchronization connection is described in the figures with a dashed line. In addition, preferably there is a synchronization connection between the brakes 5 and 5′ in such a way that if the brake 5 triggers, the second brake 5′ also triggers. Preferably, however, triggering of the brake 5′ does not cause triggering of the brake 5, in which case when the elevator car is at overspeed only the brake 5′ in the bottom end of the elevator hoistway triggers, because in this case additional power for the braking is not needed when the rope masses are low owing to the car position. Thus when the elevator car is in the bottom parts of the hoistway, too sudden a deceleration of the elevator car is avoided. Synchronization of the brakes 5 and 5′ can also be arranged by the aid of a simple mechanical structure. FIG. 6 presents one preferred embodiment for synchronization between the brakes 5 and 5′. Displacement of the brake 5 into a braking position pulls, via the flexible member 20, the lever 11′ of the brake 5′ upwards, causing triggering of the brake 5′. However, triggering of the brake 5′ does not cause triggering of the brake 5, because the flexible member 20 can transmit force in only one direction. This can be realized also with another type of lever system.

The average mass per meter means the mass of the section of the loop/the length of it. It would be possible to make the average mass per meter high also by connecting weights to the rope forming the loop at suitable points, e.g. at a distance from each other. Preferably, however, the rope comprises just sections one after the other that have a constant mass per meter.

The aforementioned means for starting the braking could alternatively be of another type, such as e.g. a force sensor, the forces exerted on which, including the pull exerted by the rope loop, would cause displacement of the brake 5 into a braking state when certain criteria of said forces are fulfilled. In this case e.g. the force sensor could disconnect the electric power of the solenoid pulling the brake pad out of the braking position (against the spring force).

It is obvious to the person skilled in the art that in developing the technology the basic concept of the invention can be implemented in many different ways. The invention and the embodiments of it are not therefore limited to the examples described above, but instead they may be varied within the scope of the claims. It is also obvious that the functions can be performed in many alternative ways.

1. An elevator, which comprises:
an elevator hoistway,
an elevator car configured to move with a certain range of movement in the elevator hoistway,
a brake on the elevator car, which brake can be displaced between a braking state and a non-braking state, in which braking state the brake is configured to grip a structure in the elevator hoistway for braking the elevator car,
a rope loop, which rope loop hangs in its position supported by a diverting pulley of the top end, said diverting pulley being supported in a manner allowing rotation in the proximity of the top end of the range of movement of the elevator car, and the rope loop is connected to the brake, which brake is configured to be such that it can displace into a braking state as a consequence of a pull exerted on the brake by the rope loop,
wherein the rope loop comprises a first section and second section consecutive to each other, which have average masses per meter of different magnitudes.

2. The elevator according to claim 1, wherein the heavier section of the sections is arranged to run over the diverting pulley of the top end from the second side of the diverting pulley to the first side when the elevator car descends.

3. The elevator according to claim 1, wherein the elevator comprises a diverting pulley of the bottom end, said diverting pulley being supported in a manner allowing rotation in the proximity of the bottom end of the range of movement of the elevator car, under which diverting pulley the rope loop travels and from which diverting pulley the rope loop continues upwards to the diverting pulley of the top end, and the light section is arranged when the elevator car descends to run below the diverting pulley of the bottom end and to rise towards the diverting pulley of the top end.

4. The elevator according to claim 1, wherein a part of the rope loop is connected to a device for starting braking of the brake such that a pull of the part of the rope loop is transmitted to the starting device, and the brake is configured to displace into a braking state when the forces exerted on the starting device fulfill certain criteria.

5. The elevator according to claim 1, wherein the rope loop comprises a loop half that is heavier in its average mass per meter and a loop half that is lighter in its average mass per meter, which heavier half rises upwards from the elevator car and the lighter half descends down from the elevator car.

6. The elevator according to claim 1, wherein the rope loop comprises a first section, which descends downwards from the elevator car, and following it the second section, which continues back to the elevator car traveling over the diverting pulley of the top end, which second section is heavier than the first section in its average mass per meter.

7. The elevator according to claim 1, wherein the light section and heavy section have an essentially constant mass per meter over their whole length, or at least over most of their length.

8. The elevator according to claim 1, wherein the border point of the light section and the heavy section rises in the elevator hoistway when the elevator car descends.

9. The elevator according to claim 1, wherein the elevator also comprises a second brake on the elevator car, which brake can be displaced between a braking state and a non-braking state, in which braking state the second brake is configured to grip a structure in the elevator hoistway for braking the elevator car, and also a displacement device configured to displace the second brake between a braking state and a non-braking state.

10. The elevator according to claim 9, wherein the displacement device forms an overspeed governor, which displaces the second brake into a braking state when the speed of the elevator car exceeds a predefined speed.

11. The elevator according to claim 1, wherein the brake and the second brake are connected to each other in such a way that triggering of the brake causes triggering of the second brake, but triggering of the second brake does not cause triggering of the brake.

12. The elevator according to claim 1, wherein in the braking state, the brake is configured to grip a guide rail of the elevator car, for braking the elevator car.

13. The elevator according to claim 1, wherein a part of the rope loop on the first side of the diverting pulley of its top end is connected to a device for starting braking of the brake such that a pull of the part of the rope loop on the first side of the diverting pulley of its top end is transmitted to the starting device, and the brake is configured to displace into a braking state when the forces exerted on the starting device fulfill certain criteria.

14. The elevator according to claim 2, wherein the elevator comprises a diverting pulley of the bottom end, said diverting pulley being supported in a manner allowing rotation in the proximity of the bottom end of the range of movement of the elevator car, under which diverting pulley the rope loop travels and from which diverting pulley the rope loop continues upwards to the aforementioned diverting pulley of the top end, and the light section is arranged when the elevator car descends to run below the diverting pulley of the bottom end and to rise towards the diverting pulley of the top end.

15. The elevator according to claim 2, wherein a part of the rope loop, more particularly the part of the rope loop on the first side of the diverting pulley of its top end, is connected to a means for starting braking of the brake such that a pull of the part of the rope loop, more particularly of the part of the rope loop on the first side of the diverting pulley of its top end, is transmitted to the starting means, and in that the brake is configured to displace into a braking state when the forces exerted on the starting means fulfill certain criteria.

16. The elevator according to claim 3, wherein a part of the rope loop, more particularly the part of the rope loop on the first side of the diverting pulley of its top end, is connected to a means for starting braking of the brake such that a pull of the part of the rope loop, more particularly of the part of the rope loop on the first side of the diverting pulley of its top end, is transmitted to the starting means, and in that the brake is configured to displace into a braking state when the forces exerted on the starting means fulfill certain criteria.

17. The elevator according to claim 2, wherein the rope loop comprises a loop half that is heavier in its average mass per meter and a loop half that is lighter in its average mass per meter, which heavier half rises upwards from the elevator car and the lighter half descends down from the elevator car.

18. The elevator according to claim 3, wherein the rope loop comprises a loop half that is heavier in its average mass per meter and a loop half that is lighter in its average mass per meter, which heavier half rises upwards from the elevator car and the lighter half descends down from the elevator car.

19. The elevator according to claim 4, wherein the rope loop comprises a loop half that is heavier in its average mass per meter and a loop half that is lighter in its average mass per meter, which heavier half rises upwards from the elevator car and the lighter half descends down from the elevator car.

20. The elevator according to claim 2, wherein the rope loop comprises a first section, which descends downwards from the elevator car, and following it the aforementioned second section, which continues back to the elevator car traveling over the aforementioned diverting pulley of the top end, which second section is heavier than the first section in its average mass per meter.
